(19) United States
(12) Patent Application Publication
(10) Pub. No.: US 2021/0096849 A1
(43) Pub. Date: Apr. 1, 2021

(54) INFORMATION PROCESSING SYSTEM AND INFORMATION PROCESSING APPARATUS

(71) Applicant: Fujitsu Client Computing Limited, Kawasaki-shi (JP)

(72) Inventors: Akira TAKEUCHI, Kawasaki (JP); Masatoshi KIMURA, Kawasaki (JP); Hiroki TERAMOTO, Kawasaki (JP)

(21) Appl. No.: 16/936,599

(22) Filed: Jul. 23, 2020

(30) Foreign Application Priority Data
Sep. 30, 2019 (JP) 2019-179739

(51) Int. Cl. G06F 8/65; G06F 8/656; G06F 13/10; G06F 13/12

(52) U.S. Cl. CPC G06F 8/66; G06F 13/122; G06F 13/102; G06F 8/656

(57) ABSTRACT

An information processing apparatus includes a controller. A peripheral includes a converter and a device. The converter performs conversion of communication interface for inputs into the device based on a mode setting. When updating the embedded software of the device, the controller sets the converter to conversion mode to have the converter execute conversion of embedded software outputted using a first communication interface from the first communication interface to the second communication interface, and performs updating of the embedded software using the second communication interface. When not updating the embedded software, the controller sets the converter in non-conversion mode, stops the conversion from the first communication interface to the second communication interface, and stops the updating of the embedded software.

### CROSS-REFERENCE TO RELATED APPLICATION

This application is based upon and claims the benefit of priority of the prior Japanese Patent Application No. 2019-179739, filed on Sep. 30, 2019, the entire contents of which are incorporated herein by reference.

### FIELD

The embodiments discussed herein are related to an information processing system, an information processing apparatus, and a program.

### BACKGROUND

An information processing system where communication between a host PC (Personal Computer) and coprocessors is performed using an expansion bus such as PCIe (Peripheral Component Interconnect Express, registered trademark) has been developed.

This information processing system is equipped with various devices in which firmware, that is, embedded software, has been installed. Example devices include a PCIe bridge controller, which performs relaying control according to PCIe, and a power supply control unit that controls a power supply. These devices execute control based on firmware.

See, for example, Japanese Laid-open Patent Publication No. 2019-101900.

It is customary to update firmware to add new functions and correct problems. A dedicated external interface is normally provided for firmware updates so that the firmware is rewritten from an external appliance. When this arrangement is used however, the task of updating firmware tends to be complicated.

On the other hand, there is also a method where a host PC uses a general-purpose interface (for example, USB (Universal Serial Bus)) to access a target device and update the firmware. In this arrangement, it is conventional to always keep a port on so that the firmware may be updated at any time from the port of the general-purpose interface.

However, when there is a port which is always on, the port will always be accessible to other devices, such as during a period when the firmware is not being updated, resulting in the problem of this producing a security hole.

### SUMMARY

According to an aspect, there is provided an information processing system which includes: a peripheral including a device that operates on embedded software and a converter that performs conversion of communication interface for inputs into the device based on a mode setting; and an information processing apparatus including a controller that sets, when updating the embedded software of the device, the converter in a conversion mode to cause the converter to perform conversion of embedded software that has been outputted for a first communication interface from the first communication interface to a second communication interface and performs updating of the embedded software of the device using the second communication interface, and sets, when not updating the embedded software, the converter in a non-conversion mode to stop the conversion from the first communication interface to the second communication interface and stops updating of the embedded software of the device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is useful in explaining an example of an information processing system according to a first embodiment;

FIG. 2 depicts an example configuration of an information processing system according to a second embodiment;

FIG. 3 depicts an example application of an information processing system to edge computing;

FIG. 4 depicts an example hardware configuration of a host PC;

FIG. 5 is useful in explaining an example operation of firmware updating of a PCIe bridge controller;

FIG. 6 is useful in explaining example operations during a firmware update of the PCIe bridge controller;

FIG. 7 is useful in explaining example operations during a firmware update of a power supply control unit;

FIG. 8 depicts one example of an operation sequence for updating firmware of a PCIe bridge controller;

FIG. 9 depicts an example of an operation sequence for updating firmware of a power supply control unit; and

FIG. 10 depicts an example of an operation sequence for updating firmware of a power supply control unit.

### DESCRIPTION OF EMBODIMENTS

Several embodiments will be described below with reference to the accompanying drawings.

### First Embodiment

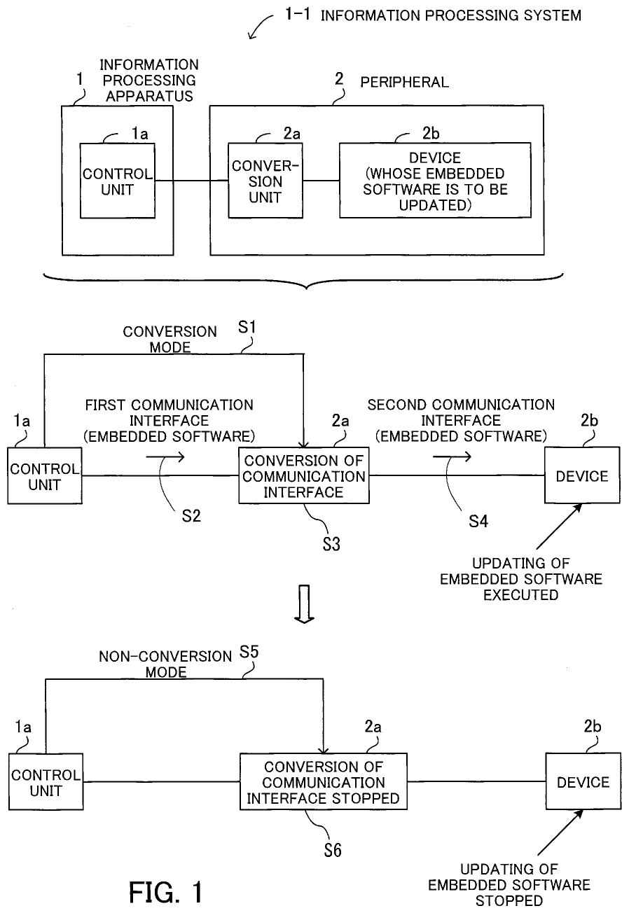

FIG. 1 is useful in explaining an example of an information processing system according to a first embodiment. The information processing system 1-1 includes an information processing apparatus 1 and a peripheral 2. The information processing apparatus 1 includes a control unit 1a. The peripheral 2 includes a conversion unit 2a and a device 2b that operates on embedded software.

The conversion unit 2a performs conversion of communication interface for inputs into the device 2b based on a mode setting from the control unit 1a. The conversion unit 2a may be disposed on the information processing apparatus 1 side, and the control unit 1a may share the functions of the conversion unit 2a.

When updating the embedded software in the device 2b, the control unit 1a sets the conversion unit 2a into a conversion mode for embedded software outputted using a first communication interface and has the conversion unit 2a execute conversion from the first communication interface to a second communication interface. The control unit 1a then updates the embedded software in the device 2b using the second communication interface.

When not updating the embedded software in the device 2b, the control unit 1a sets the conversion unit 2a in a non-conversion mode so that the conversion unit 2a stops conversion from the first communication interface to the second communication interface and the updating of the embedded software of the device 2b is stopped.

The operation flow of the control unit 1a will now be described.

[Step S1] The control unit 1a sets the conversion unit 2a in the conversion mode.

[Step S2] The control unit 1a outputs embedded software that is outputted using the first communication interface.

[Step S3] The conversion unit 2a executes conversion from the first communication interface to the second communication interface.

[Step S4] The embedded software of the device 2b is updated (rewritten) using the second communication interface.

[Step S5] The control unit 1a sets the conversion unit 2a in the non-conversion mode.

[Step S6] The conversion unit 2a stops the conversion from the first communication interface to the second communication interface. The updating of the embedded software of the device 2b is stopped.

Note that although the control unit 1a normally stops the outputting of embedded software when the control unit 1a has set the conversion unit 2a in the non-conversion mode, even when embedded software is outputted from the control unit 1a, conversion of communication interface by the conversion unit 2a is stopped. This means that the updating of the embedded software of the device 2b is stopped.

As described above, in the information processing system 1-1, when updating the embedded software in the device 2b, the control unit 1a sets the conversion unit 2a in the conversion mode so that conversion from the first communication interface to the second communication interface is executed and the embedded software is updated using the second communication interface.

When the embedded software is not being updated, the control unit 1a sets the conversion unit 2a in the non-conversion mode to stop conversion from the first communication interface to the second communication interface and stop the updating of the embedded software.

By operating in this way, the communication interface is converted and the updating of embedded software is performed only during an actual updating process for the embedded software, so that there is no port that is always on as was the case in the past. This means that it is possible to eliminate a vulnerability that allowed undesirable access from other devices. Accordingly, it is possible to prevent security holes and to update embedded software with a reduced risk of vulnerabilities.

### Second Embodiment

Next, as a second embodiment, an information processing system which uses PCIe, which is one example of an expansion bus, will be described. Note that in the following description, the embedded software is indicated as “firmware”.

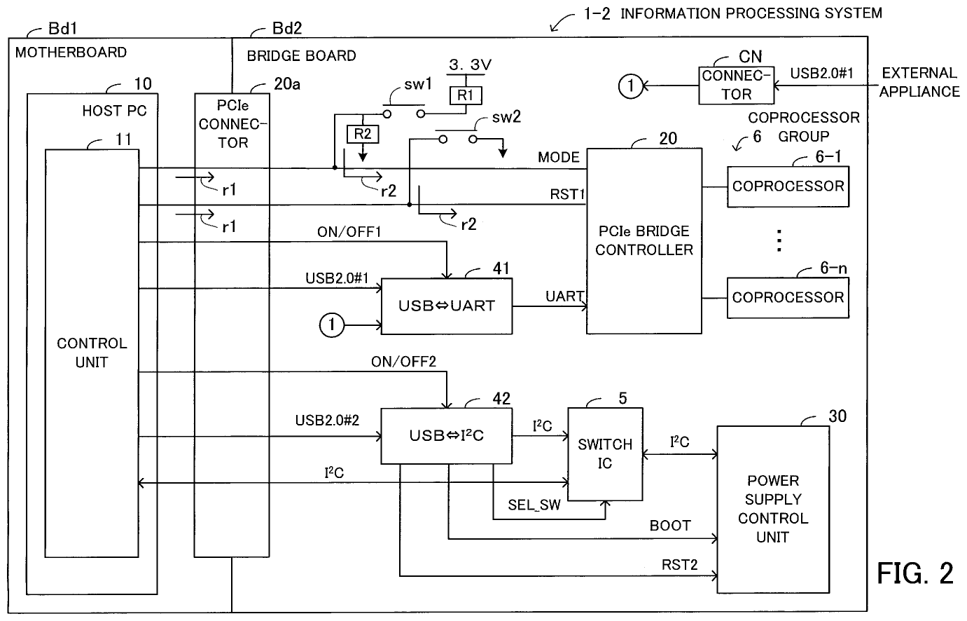

FIG. 2 depicts an example configuration of an information processing system according to the second embodiment. An information processing system 1-2 includes a motherboard Bd1 and a bridge board Bd2 which are connected via a PCIe connector 20a. The motherboard Bd1 corresponds to the information processing apparatus 1 in FIG. 1, and the bridge board Bd2 corresponds to the peripheral 2 in FIG. 1.

A host PC 10 is mounted on the motherboard Bd1. The host PC 10 includes a control unit 11. A PCIe bridge controller 20, the PCIe connector 20a, a power supply control unit 30, interface conversion ICs (Integrated Circuits) 41 and 42, a switch IC 5, a coprocessor group 6, a connector CN, switches sw1 and sw2, and resistors R1 and R2 are mounted on the bridge board Bd2.

The control unit 11 is realized by a processor (computer), has the functions of the control unit 1a in FIG. 1, and is in charge of operations of the host PC 10 and main functions for running the system. The PCIe bridge controller 20 is a relay device that relays and controls communication between the motherboard Bd1 and the bridge board Bd2 via the PCIe connector 20a that is a relay connector that has an expansion bus.

The PCIe bridge controller 20 acts as a bridge connector for the coprocessor group 6, which includes a plurality of coprocessors 6-1, . . . , 6-n, and relays communication between the host PC 10 and the coprocessor group 6 and communication between the coprocessors 6-1, . . . , 6-n themselves. Note that the PCIe bridge controller 20 operates based on firmware, and this firmware is updated by firmware updating control by the control unit 11.

The power supply control unit 30 is a power supply device that controls the supplying of power to each device that constructs the system. The power supply control unit 30 operates based on firmware, and this firmware is also updated by firmware updating control by the control unit 11.

The interface conversion ICs 41 and 42 are ICs that perform conversion of communication interface based on a mode setting from the control unit 11, and realize the functions of the conversion unit 2a in FIG. 1. The interface conversion IC 41 converts from a general-purpose serial bus communication interface to a general-purpose asynchronous serial bus communication interface as the conversion from the first communication interface to the second communication interface. In more detail, conversion of communication interface from USB to UART (Universal Asynchronous Receiver Transmitter) is performed (conversion from UART to USB is also possible).

The interface conversion IC 42 includes a processor (computer) and performs conversion from a first communication interface to a second communication interface based on a mode setting from the control unit 11.

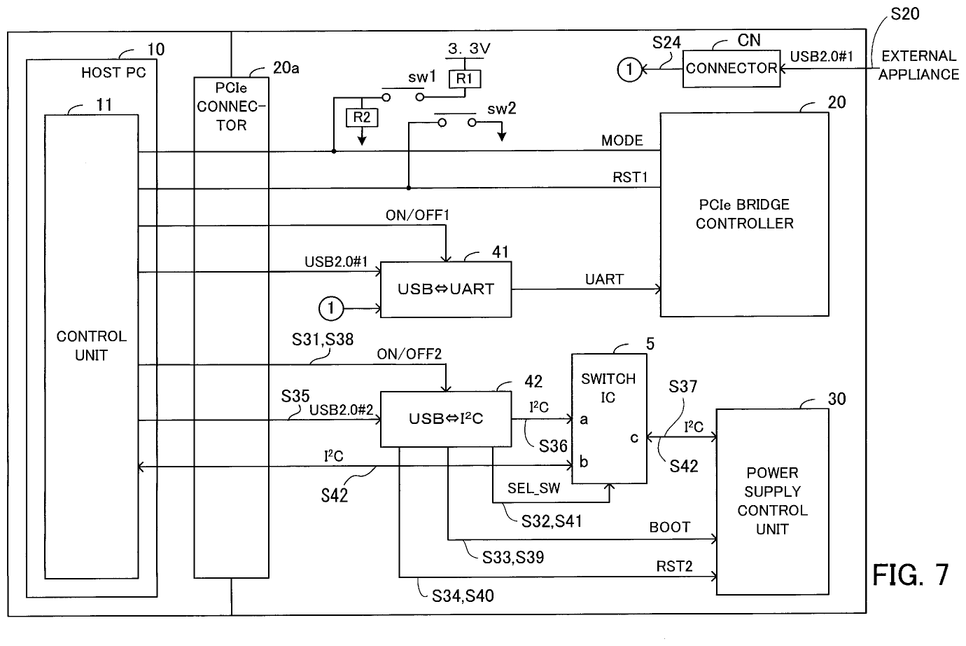

Conversion from a general-purpose serial bus communication interface to a synchronous serial bus communication interface is performed as the conversion from the first communication interface to the second communication interface. In more detail, the interface conversion IC 42 is an integrated circuit that performs conversion of communication interface from USB to I²C (Inter-Integrated Circuit, registered trademark) (I²C to USB conversion is also possible). The interface conversion IC 42 also controls switching by the switch IC 5 (described later with reference to FIGS. 7, 9 and 10).

The coprocessors 6-1, . . . , 6-n are computational processors that perform AI (Artificial Intelligence) inference processing and parallel computational processing such as image processing. As examples, the coprocessors 6-1, . . . , 6-n may use GPUs (Graphics Processing Units) or FPGA (Field Programmable Gate Arrays). Note that the coprocessors 6-1, . . . , 6-n may be combinations of a CPU and another computational processor, such as a GPU.

The connector CN is a connector for connecting signals transmitted from outside using the first communication interface. In more detail, the connector CN is connected to an external appliance (a maintenance terminal or the like) that outputs USB interface signals.

The switches sw1 and sw2 are manual switches operated by the user. One end of the switch sw1 is connected via the resistor R1 to a 3.3V power source, and the other end of the switch sw1 is connected to one end of the resistor R2 and to a line on which a MODE signal outputted from the control unit 1a flows. The other end of the resistor R2 is connected to GND. One end of the switch sw2 is connected to GND, and the other end of the switch sw2 is connected to a line on which an RST1 signal outputted from the control unit 1a flows.

The respective signals and data flowing in the system will now be described. The two signals MODE and RST1 are state setting signals that set the PCIe bridge controller 20 in a firmware updateable state and a firmware updating stopped state (a state where the firmware is not to be updated).

There are two routes on which the MODE signal and the RST1 signal flow to the PCIe bridge controller 20. In FIG. 2, a first route r1 is a route that flows from the control unit 11 toward the PCIe bridge controller 20. The second route r2 is a route that flows from the switches sw1 and sw2 toward the PCIe bridge controller 20 when the switches sw1 and sw2 have been operated.

When the route r1 is used, the PCIe bridge controller 20 is set in the firmware updateable state or the firmware updating stopped state by the control unit 11. When the route r2 is used, the PCIe bridge controller 20 is set in the firmware updateable state or the firmware updating stopped state by the switches sw1 and sw2.

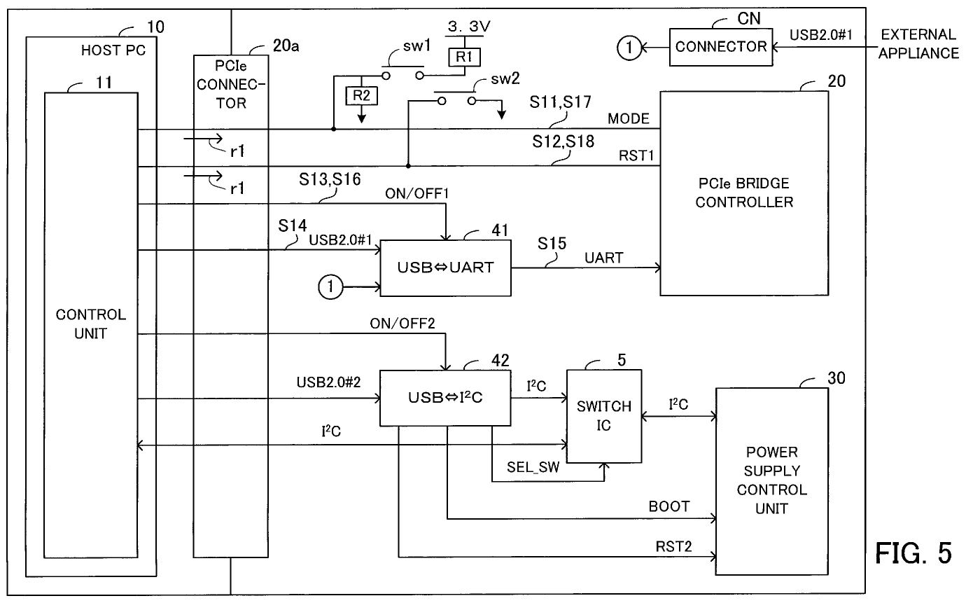

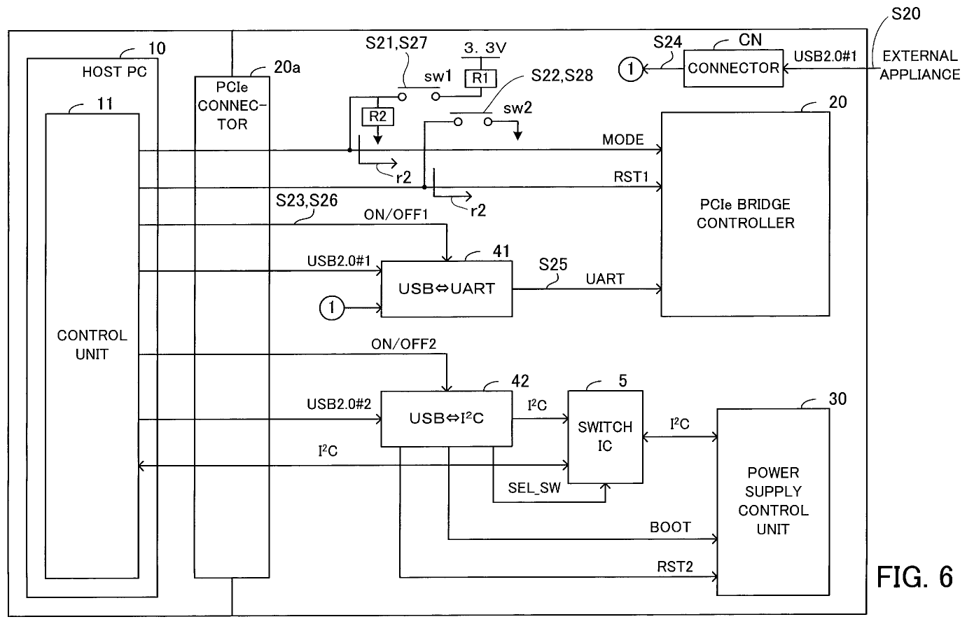

In this way, by providing the two routes on which the state setting signals including the MODE signal and the RST1 signal flow, it becomes possible to update the firmware of the PCIe bridge controller 20 not only from the host PC 10 but also from an external appliance connected to the connector CN. Firmware updating from the host PC 10 will be described later with reference to FIG. 5 and firmware updating from the external appliance will be described later with reference to FIG. 6.

The ON/OFF1 signal is a signal used for mode setting and is outputted from the control unit 11 to the interface conversion IC 41. The ON/OFF1 signal sets a communication interface conversion function of the interface conversion IC 41 in a conversion mode or a non-conversion mode.

The ON/OFF2 signal is a signal used for mode setting and is outputted from the control unit 11 to the interface conversion IC 42. The ON/OFF2 signal sets a communication interface conversion function of the interface conversion IC 42 in a conversion mode or a non-conversion mode.

The two signals BOOT and RST2 are outputted from the interface conversion IC 42 to the power supply control unit 30, and are state setting signals used to set the power supply control unit 30 in the firmware updateable state or the firmware updating stopped state.

The SEL_SW signal is a signal that is outputted from the interface conversion IC 42 to the switch IC 5, and switches the switching state of the switch IC 5. As one example, when the SEL_SW signal is at the H level, the switch IC 5 is placed in a first switching state where the interface conversion IC 42 and the power supply control unit 30 are connected by an I²C communication interface.

When the SEL_SW signal is at the L level, the switch IC 5 is placed in a second switching state where the control unit 11 and the power supply control unit 30 are connected by the I²C communication interface.

On the other hand, when updating the firmware of the PCIe bridge controller 20, the control unit 11 outputs firmware data for the PCIe bridge controller 20 to the interface conversion IC 41 using a USB 2.0#1 communication interface.

The interface conversion IC 41 performs conversion from USB into UART and transmits UART communication interface firmware to the PCIe bridge controller 20.

When updating the firmware of the power supply control unit 30, the control unit 11 outputs the firmware data for the power supply control unit 30 to the interface conversion IC 42 via the USB 2.0#2 communication interface.

The interface conversion IC 42 performs conversion from USB to I²C and transmits I²C communication interface firmware to the power supply control unit 30 via the switch IC 5. The power supply control unit 30 supplies power to predetermined devices during normal operation. During normal operation, aside from supplying power, the power supply control unit 30 is capable of data communication with the control unit 11 using the I²C interface.

Note that the firmware data for the PCIe bridge controller 20 that has been outputted from an external appliance and is in USB 2.0#1 communication interface protocol is inputted via the connector CN into the interface conversion IC 41.

Application to Edge Computing

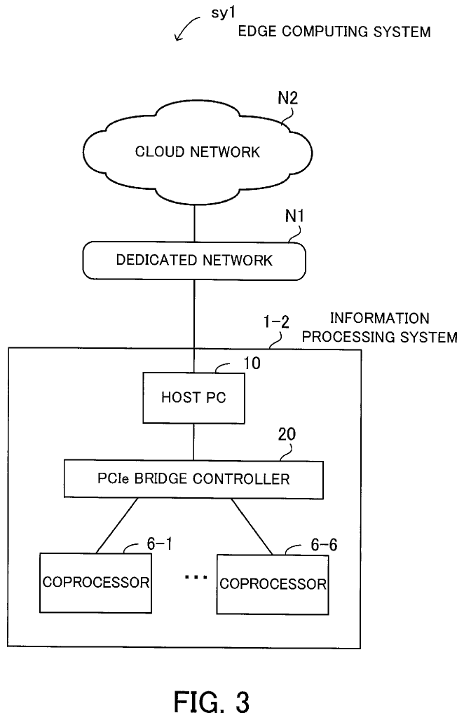

FIG. 3 depicts an example application of the information processing system to edge computing. It is possible to regard the host PC 10 described above with reference to FIG. 2 as an edge server and apply the information processing system 1-2 to edge computing.

An edge computing system sy1 includes the information processing system 1-2, a dedicated network N1 (such as the Internet), and a cloud network N2. The host PC 10 in the information processing system 1-2 is connected to the dedicated network N1 and the dedicated network N1 is connected to the cloud network N2.

The host PC 10 collects data that has been subjected to distributed processing by the coprocessors 6-1, . . . , 6-n via the PCIe bridge controller 20, and transmits the data via the dedicated network N1 to the cloud network N2.

With this configuration, it is possible to save resources on the cloud and perform processing at the edge. By doing so, since the response time taken by processing via the cloud network N2 is reduced, real-time response is ensured.

Since data is processed at the host PC 10 and the result is transmitted to the cloud network N2, it is possible to protect the confidentiality of the data. In addition, since data is processed at the host PC 10 and only the required data is transmitted to the cloud network N2, it is possible to reduce the amount of communication.

Hardware Configuration

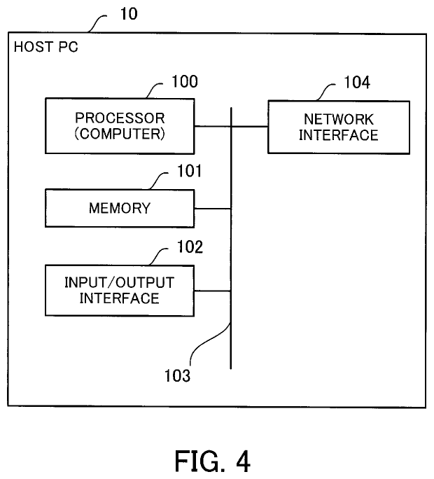

FIG. 4 depicts an example hardware configuration of the host PC. The host PC 10 is subject to overall control by a processor (computer) 100 with the functions of the control unit 11.

The processor 100 is connected via a bus 103 to a memory 101 and a plurality of peripherals. The processor 100 may be a multiprocessor. As examples, the processor 100 is a CPU (Central Processing Unit), an MPU (Micro Processing Unit), a DSP (Digital Signal Processor), an ASIC (Application Specific Integrated Circuit), or a PLD (Programmable Logic Device). The processor 100 may also be a combination of two or more of a CPU, an MPU, a DSP, an ASIC, and a PLD.

The memory 101 corresponds to a storage unit of the host PC 10 and is used for example as a main storage device. At least part of a program of an OS (Operating System) and/or an application program to be executed by the processor 100 is/are temporarily stored in the memory 101. The memory 101 also stores various data used in processing by the processor 100.

The memory 101 is also used as an auxiliary storage device of the host PC 10 and stores an OS program, application programs, and various data. As an auxiliary storage device, the memory 101 may include a semiconductor storage device, such as flash memory or a solid state drive (SSD), and/or a magnetic recording medium, such as a hard disk drive (HDD).

The peripherals connected to the bus 103 are an input/output interface 102 and a network interface 104. The input/output interface 102 may be connected to a monitor (for example, LEDs (Light Emitting Diodes) or an LCD (Liquid Crystal Display)) that functions as a display device which displays the state of the host PC 10 according to an instruction from the processor 100.

In addition, the input/output interface 102 may be connected to information input devices, such as a keyboard and a mouse, and transmits signals sent from the information input devices to the processor 100. In addition, the input/output interface 102 also functions as a communication interface for connecting peripherals.

As one example, the input/output interface 102 may be connected to an optical drive device that reads data recorded on an optical disk using laser light or the like. Optical discs include Blu-ray discs (registered trademark), CD-ROM (Compact Disc-Read Only Memory), and CD-R (Recordable)/RW (Rewritable).

The input/output interface 102 may be connected to a memory device and/or a memory reader/writer. The memory device is a recording medium equipped with a function of communicating with the input/output interface 102. The memory reader/writer is a device that writes data in a memory card or reads data from a memory card. A memory card is a card-type recording medium.

The network interface 104 is connected to a network and performs network interface control. As examples, a NIC (Network Interface Card), a wireless LAN (Local Area Network) card, or the like may be used. The data received by the network interface 104 is outputted to the memory 101 and/or the processor 100.

By using the hardware configuration described above, it is possible to realize the processing functions of the host PC 10. Note that it is also possible for the interface conversion IC 42 to include a computer and be realized by the same hardware depicted in FIG. 4.

The host PC 10 is capable of the processing in the present embodiments through the processor 100 executing predetermined programs. As one example, by executing programs recorded on a computer-readable recording medium, the host PC 10 is capable of realizing the processing functions in the present embodiments. It is possible to record a program including the processing content to be executed by the host PC 10 on a variety of recording media.

As one example, it is possible to store a program to be executed by the host PC 10 in an auxiliary storage device. The processor 100 loads at least part of the program in the auxiliary storage device into the main storage device and executes the program.

It is also possible to record the program on a portable recording medium such as an optical disc, a memory device, a memory card, or the like. As one example, a program stored on a portable recording medium is installed into the auxiliary storage device under control by the processor 100 so as to become executable. The processor 100 may also be capable of reading out and executing the program directly from a portable recording medium.

Firmware Updating of PCIe Bridge Controller

Next, updating of the firmware of the PCIe bridge controller 20 will be described. When the firmware of the PCIe bridge controller 20 is updated, there are two different cases, a case where updating is performed with firmware outputted from the control unit 11 and a case where updating is performed with firmware outputted from an external appliance connected to the connector CN, which will now be described with FIGS. 5 and 6, respectively.

FIG. 5 is useful in explaining an example operation of firmware updating of a PCIe bridge controller and depicts the case where updating is performed with firmware outputted from the control unit 11.

[Step S11] The control unit 11 outputs an H-level MODE signal as one example of a predetermined level. This MODE signal is transmitted to the PCIe bridge controller 20 via the route r1.

[Step S12] The control unit 11 outputs an L-level RST1 signal as one example of a predetermined level. This RST1 signal is transmitted to the PCIe bridge controller 20 via the route r1.

In steps S11 and S12, when the firmware of the PCIe bridge controller 20 is updated, the MODE signal is set at the H level, and then the PCIe bridge controller 20 is reset by an L-level signal RST1. By doing so, the PCIe bridge controller 20 is placed in the firmware updateable state.

[Step S13] The control unit 11 sets the ON/OFF1 signal at the H level, for example, to turn on the interface conversion IC 41 and set the conversion mode. The interface conversion IC 41 drives the conversion of communication interface.

[Step S14] The control unit 11 outputs update data for the firmware. In more detail, the control unit 11 transmits update data for a USB interface (for example, USB 2.0#1) to the interface conversion IC 41.

[Step S15] The interface conversion IC 41 converts the firmware update data for a USB interface to data for a UART interface, and transmits the UART interface firmware update data to the PCIe bridge controller 20. By doing so, the firmware of the PCIe bridge controller 20 is updated.

[Step S16] At the end of the firmware update, the control unit 11 sets the ON/OFF1 signal at the L level, for example, to turn off the interface conversion IC 41 and thereby set the non-conversion mode. The interface conversion IC 41 stops the conversion of communication interface.

[Step S17] The control unit 11 outputs an L-level MODE signal as one example of a predetermined level. This MODE signal is transmitted to the PCIe bridge controller 20 via the route r1.

[Step S18] The control unit 11 outputs an L-level RST1 signal as one example of a predetermined level. This signal RST1 is transmitted to the PCIe bridge controller 20 via the route r1.

In steps S17 and S18, when updating of the firmware of the PCIe bridge controller 20 is stopped (that is, the PCIe bridge controller 20 is placed in a normal operation mode), the control unit 11 sets the MODE signal at the L level, and the PCIe bridge controller 20 is then reset by the L-level signal RST1. As a result, the PCIe bridge controller 20 stops the updating of firmware and enters the normal operation state (the normal relay control state).

In this way, the control unit 11 sets the PCIe bridge controller 20 in the firmware updateable state based on state setting signals (the MODE signal and the RST1 signal) outputted via the route r1. Communication interface conversion by the interface conversion IC 41 is then driven to perform conversion from the USB interface to the UART interface and the firmware of the PCIe bridge controller 20 is then updated using the UART interface.

The control unit 11 also sets the PCIe bridge controller 20 in the firmware updating stopped state based on the state setting signals outputted via the route r1. Conversion of communication interface by the interface conversion IC 41 is then stopped and firmware updating of the PCIe bridge controller 20 is stopped.

By performing this operation, the communication interface is converted from USB to UART and the firmware is updated only when the firmware of the PCIe bridge controller 20 is being updated.

This means that it is possible to eliminate the vulnerability of having a port that is always on in order for firmware to be outputted, as was the case in the past. Accordingly, it is possible to prevent security holes and to safely and efficiently update the firmware of the PCIe bridge controller 20.

FIG. 6 is useful in explaining example operations during a firmware update of the PCIe bridge controller. A case where updating is performed with firmware outputted from an external appliance connected to the connector CN is depicted.

[Step S20] An external appliance is connected to the connector CN.

[Step S21] When the switch sw1 is turned on, the switch sw1 outputs an H-level MODE signal. This MODE signal is transmitted to the PCIe bridge controller 20 via the route r2.

[Step S22] When the switch sw2 is turned on, the switch sw2 outputs an L-level RST1 signal. This RST1 signal is transmitted to the PCIe bridge controller 20 via the route r2.

In steps S21 and S22, when the firmware of the PCIe bridge controller 20 is updated, the MODE signal is set to the H level by operating the switches sw1 and sw2, and after this the PCIe bridge controller 20 is reset by the L-level RST1 signal. By doing so, the PCIe bridge controller 20 is placed in the firmware updateable state.

[Step S23] The control unit 11 sets the ON/OFF1 signal at the H level, for example, to turn on the interface conversion IC 41 and set the conversion mode. As a result, the interface conversion IC 41 drives the conversion of communication interface.

[Step S24] The connector CN transmits the update data for the firmware outputted from the connected external appliance to the interface conversion IC 41. That is, the connector CN transmits update data for a USB interface (for example, USB 2.0#1) outputted from the external appliance to the interface conversion IC 41.

[Step S25] The interface conversion IC 41 converts the firmware update data for a USB interface to data for a UART interface, and transmits the UART interface firmware update data to the PCIe bridge controller 20. By doing so, the firmware of the PCIe bridge controller 20 is updated.

[Step S26] At the end of the firmware update, the control unit 11 sets the ON/OFF1 signal at the L level, for example, to turn off the interface conversion IC 41 and thereby set the non-conversion mode. The interface conversion IC 41 stops the conversion of communication interface.

[Step S27] After the firmware is updated, the switch sw1 is turned off so that the switch sw1 outputs an L-level MODE signal. This MODE signal is transmitted to the PCIe bridge controller 20 via the route r2.

[Step S28] The switch sw2 is turned on, so that the switch sw2 outputs an L-level RST1 signal. This RST1 signal is transmitted to the PCIe bridge controller 20 via the route r2.

In steps S27 and S28, when updating of the firmware of the PCIe bridge controller 20 is stopped (that is, the PCIe bridge controller 20 is placed in the normal operation mode), the switch sw1 is turned off, the MODE signal is set at the L level, and after this the switch sw2 is turned on so that the PCIe bridge controller 20 is reset by the L-level RST1 signal. As a result, the PCIe bridge controller 20 stops the updating of firmware and enters the normal operation state.

In this way, the PCIe bridge controller 20 is provided with a mechanism capable of updating the firmware not only from the host PC 10 but also from an external appliance. This means that it is possible to update the firmware of the PCIe bridge controller 20 without intervention by the host PC 10.

Even when the firmware is updated from an external appliance, the communication interface is converted from USB to UART and the firmware is updated only when the firmware of the PCIe bridge controller 20 is being updated.

This means that it is possible to eliminate the vulnerability of having a port that is always on in order for firmware to be outputted, which makes it possible to prevent security holes and to safely and efficiently update the firmware of the PCIe bridge controller 20.

Firmware Updating of Power Supply Control Unit

Next, a case where the firmware of the power supply control unit 30 is updated will be described. FIG. 7 is useful in explaining example operations during a firmware update of a power supply control unit.

[Step S31] The control unit 11 sets the ON/OFF2 signal to the H level, for example, to turn on the interface conversion IC 42 and set the conversion mode. The interface conversion IC 42 drives the conversion of communication interface.

[Step S32] The interface conversion IC 42 sets the SEL_SW signal at the H level, for example, to switch the switch IC 5 to a firmware updating side (or “first switching state”). That is, due to the SEL_SW signal being set at the H level, terminals a and c of the switch IC 5 are internally connected.

[Step S33] The interface conversion IC 42 transmits an H-level BOOT signal, for example, as a predetermined level to the power supply control unit 30.

[Step S34] The interface conversion IC 42 transmits an L-level RST2 signal, for example, as a predetermined level to the power supply control unit 30.

In steps S33 and S34, when the firmware of the power supply control unit 30 is to be updated, the BOOT signal is set at the H level, and then the power supply control unit 30 is reset by the L-level RST2 signal. By doing so, the power supply control unit 30 is placed in the firmware updateable state.

[Step S35] The control unit 11 (which corresponds to the output unit that outputs the embedded software) outputs update data for the firmware. That is, the control unit 11 transmits update data for a USB interface (for example, USB 2.0#2) to the interface conversion IC 42.

[Step S36] The interface conversion IC 42 converts the firmware update data for a USB interface to data for an I²C interface, and transmits the I²C interface firmware update data to the switch IC 5.

[Step S37] The I²C firmware update data is transmitted from the switch IC 5 to the power supply control unit 30, and the firmware of the power supply control unit 30 is updated.

[Step S38] At the end of the firmware update, the control unit 11 sets the ON/OFF2 signal at the L level, for example, to turn off the interface conversion IC 42 and thereby set the non-conversion mode. The interface conversion IC 42 stops the conversion of communication interface.

[Step S39] The interface conversion IC 42 outputs an L-level BOOT signal, for example, as a predetermined level.

[Step S40] The interface conversion IC 42 outputs an L-level RST2 signal, for example, as a predetermined level.

In steps S39 and S40, when the updating of the firmware of the power supply control unit 30 is stopped (that is, the power supply control unit 30 is placed in a normal operation mode), the interface conversion IC 42 sets the BOOT signal at the L level and the power supply control unit 30 is then reset by the L-level RST2 signal. As a result, the power supply control unit 30 stops the updating of firmware.

[Step S41] The interface conversion IC 42 sets the SEL_SW signal at the L level, for example, to switch the switch IC 5 to a normal operation side (or “second switching state”). That is, due to the SEL_SW signal being set at the L level, terminals b and c of the switch IC 5 are internally connected.

[Step S42] Data communication at the I²C communication interface is performed between the control unit 11 and the power supply control unit 30 via the switch IC 5.

In this way, when conversion mode is set by the control unit 11, the interface conversion IC 42 drives the conversion of communication interface to convert the USB interface to the I²C interface. In addition, the interface conversion IC 42 controls the switch IC 5 to set the first switching state where the interface conversion IC 42 and the power supply control unit 30 are connected by an I²C interface, with the I²C interface being used to update the firmware of the power supply control unit 30.

When the non-conversion mode is set by the control unit 11, the interface conversion IC 42 stops the conversion of communication interface and stops the updating of the firmware of the power supply control unit 30. In addition, the switch IC 5 is controlled to set the second switching state where the control unit 11 and the power supply control unit 30 are connected by the I²C interface, and communication between the control unit 11 and the power supply control unit 30 is executed via the switch IC 5 using the I²C interface.

By operating in this way, the communication interface is converted from USB to I²C and the firmware is updated only when the firmware of the power supply control unit 30 is being updated. This means that it is possible to eliminate the vulnerability of having a port that is always on in order for firmware to be outputted, which makes it possible to prevent security holes and to safely and efficiently update the firmware of the power supply control unit 30.

The interface conversion IC 42 is also equipped with a processor (computer), and by providing the interface conversion IC 42 with some of the control functions for updating the firmware of the power supply control unit 30, it is possible to reduce the load of the control unit 11. In addition, it is possible to execute data communication between the control unit 11 and the power supply control unit 30 aside from when the firmware is being updated.

Sequence for Updating Firmware

Next, a firmware update of the PCIe bridge controller 20 depicted in FIG. 5 and a firmware update of the power supply control unit 30 depicted in FIG. 7 will be described using sequence diagrams including the control of the coprocessor group 6.

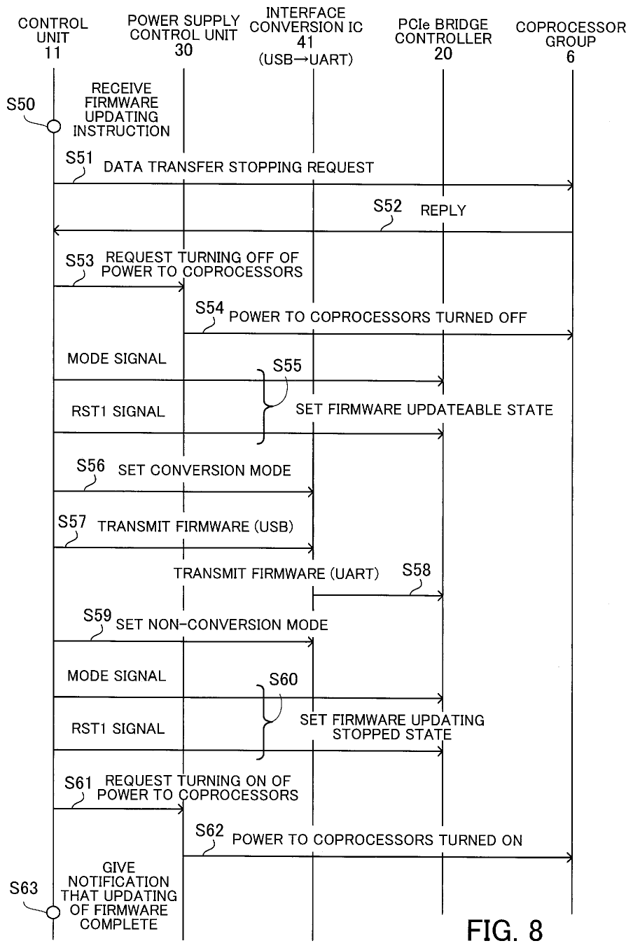

FIG. 8 depicts one example of an operation sequence for updating firmware of a PCIe bridge controller.

[Step S50] The control unit 11 receives a firmware updating instruction for the PCIe bridge controller 20 from the user.

[Step S51] The control unit 11 transmits a data transfer stopping request via the PCIe bridge controller 20 to the coprocessor group 6.

[Step S52] The coprocessor group 6 stops data transfers and replies to the control unit 11 indicating that data transfers have been stopped.

[Step S53] The control unit 11 requests the power supply control unit 30 to turn off the power to the coprocessor group 6.

[Step S54] The power supply control unit 30 turns off the power supply to the coprocessor group 6.

[Step S55] The control unit 11 places the PCIe bridge controller 20 in the firmware updateable state based on the MODE signal and the RST1 signal, which are the state setting signals. That is, the control unit 11 transmits an H-level MODE signal to the PCIe bridge controller 20 and also resets the PCIe bridge controller 20 using an L-level RST1 signal to set the PCIe bridge controller 20 in the firmware updateable state.

[Step S56] The control unit 11 turns on the ON/OFF1 signal to set the interface conversion IC 41 in the conversion mode to cause the interface conversion IC 41 to drive the conversion of communication interface.

[Step S57] The control unit 11 transmits a firmware update in USB interface protocol to the interface conversion IC 41.

[Step S58] The interface conversion IC 41 performs conversion from USB interface to UART interface and transmits UART interface firmware to the PCIe bridge controller 20 to update the firmware of the PCIe bridge controller 20.

[Step S59] On recognizing that updating of the firmware of the PCIe bridge controller 20 has been completed, the control unit 11 turns off the ON/OFF1 signal to set the interface conversion IC 41 in the non-conversion mode and thereby stops conversion of communication interface by the interface conversion IC 41.

[Step S60] The control unit 11 places the PCIe bridge controller 20 in the firmware updating stopped state based on the MODE signal and the RST1 signal which are the state setting signals. That is, the control unit 11 transmits an L-level MODE signal to the PCIe bridge controller 20 and also resets the PCIe bridge controller 20 using an L-level RST1 signal to set the PCIe bridge controller 20 in the firmware updating stopped state.

[Step S61] The control unit 11 requests the power supply control unit 30 to turn on the power to the coprocessor group 6.

[Step S62] The power supply control unit 30 turns on the power supply to the coprocessor group 6.

[Step S63] The control unit 11 gives external notification that updating of the firmware of the PCIe bridge controller 20 has been completed.

In this way, when updating the firmware of the PCIe bridge controller 20, by first temporarily stopping the supplying of power to the coprocessor group 6, it is possible to update the firmware without obstructing computational processing by the coprocessor group 6.

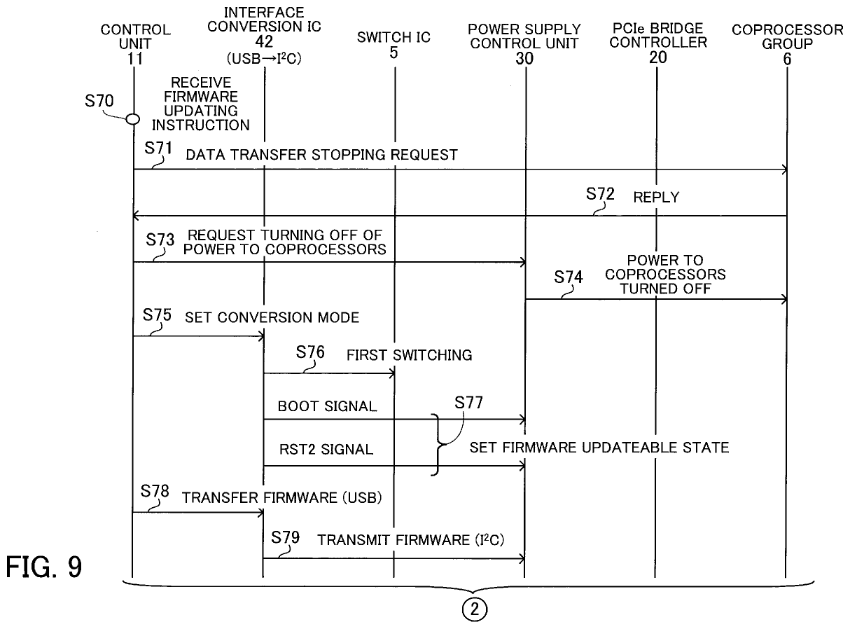

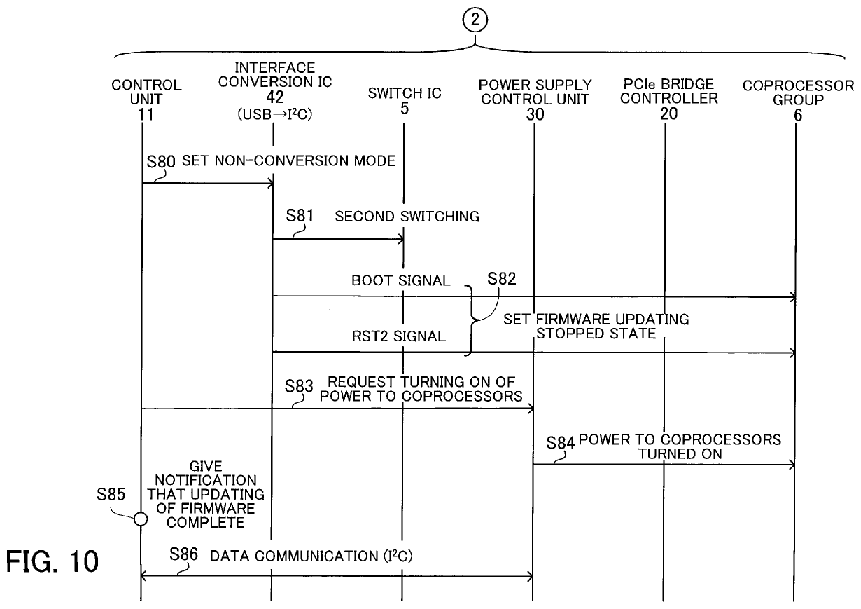

FIG. 9 and FIG. 10 depict examples of operation sequences for updating firmware of a power supply control unit.

[Step S70] The control unit 11 receives a firmware updating instruction for the power supply control unit 30 from the user.

[Step S71] The control unit 11 transmits a data transfer stopping request via the power supply control unit 30 to the coprocessor group 6.

[Step S72] The coprocessor group 6 stops data transfers and replies to the control unit 11 indicating that data transfers have been stopped.

[Step S73] The control unit 11 requests the power supply control unit 30 to turn off the power to the coprocessor group 6.

[Step S74] The power supply control unit 30 turns off the power supply to the coprocessor group 6.

[Step S75] The control unit 11 turns on the ON/OFF2 signal to set the interface conversion IC 42 in the conversion mode to cause the interface conversion IC 42 to drive the conversion of communication interface.

[Step S76] The interface conversion IC 42 sets the SEL_SW signal transmitted to the switch IC 5 at the H level to set the switch IC 5 in the first switching state where the interface conversion IC 42 and the power supply control unit 30 are connected by the I²C interface.

[Step S77] The interface conversion IC 42 places the power supply control unit 30 in the firmware updateable state based on the BOOT signal and the RST2 signal, which are the state setting signals. That is, the interface conversion IC 42 transmits the H-level MODE signal to the power supply control unit 30 and also resets the power supply control unit 30 with an L-level RST2 signal to set the power supply control unit 30 in the firmware updateable state.

[Step S78] The control unit 11 transmits a firmware update in USB interface protocol to the interface conversion IC 42.

[Step S79] The interface conversion IC 42 performs conversion from USB interface to I²C interface and transmits the I²C interface firmware to the power supply control unit 30 via the switch IC 5 to update the firmware of the power supply control unit 30.

[Step S80] On recognizing that updating of the firmware of the power supply control unit 30 has been completed, the control unit 11 turns off the ON/OFF2 signal to set the interface conversion IC 42 in the non-conversion mode and thereby stops conversion of communication interface by the interface conversion IC 42.

[Step S81] The interface conversion IC 42 sets the SEL_SW signal transmitted to the switch IC 5 at the L level to set the switch IC 5 in the second switching state where the control unit 11 and the power supply control unit 30 are connected by the I²C interface.

[Step S82] The interface conversion IC 42 places the power supply control unit 30 in the firmware updating stopped state based on the BOOT signal and the RST2 signal, which are the state setting signals. That is, the interface conversion IC 42 transmits an L-level BOOT signal to the power supply control unit 30 and also resets the power supply control unit 30 using an L-level RST2 signal to set the power supply control unit 30 in the firmware updating stopped state.

[Step S83] The control unit 11 requests the power supply control unit 30 to turn on the power to the coprocessor group 6.

[Step S84] The power supply control unit 30 turns on the power supply to the coprocessor group 6.

[Step S85] The control unit 11 gives external notification that updating of the firmware of the power supply control unit 30 has been completed.

[Step S86] Data communication via an I²C interface becomes possible between the control unit 11 and the power supply control unit 30 via the switch IC 5.

In this way, when updating the firmware of the power supply control unit 30, by first temporarily stopping the supplying of power to the coprocessor group 6, it is possible to update the firmware without obstructing computational processing by the coprocessor group 6.

Note that although in the above example, the supplying of power to the coprocessor group 6 is stopped when the firmware of the power supply control unit 30 is updated, when it is possible to update the firmware of the power supply control unit 30 in a state where power is being supplied to the coprocessor group 6, the sequence of stopping the supplying of power to the coprocessor group 6 may be omitted.

The processing functions of the information processing systems 1-1 and 1-2 of the present embodiments described above are realized by a computer. When doing so, a program in which the processing content of the functions to be provided in the information processing systems 1-1 and 1-2 are written is provided. By having a computer execute this program, the processing functions described above are realized by the computer.

The program in which the processing content is written may be recorded in advance on a computer-readable recording medium. Computer-readable recording media include magnetic storage devices, optical discs, magneto-optical recording media, and semiconductor memories. Magnetic storage devices include hard disk drives (HDD), flexible disks (FD), and magnetic tapes. Optical discs include CD-ROM/RW and the like. Magneto-optical recording media include MO (Magneto Optical) discs.

To distribute the program, as one example, a portable recording medium, such as a CD-ROM, on which the program is recorded is sold. It is also possible to store the program in a storage device of a server computer and to transfer the program from the server computer via a network to another computer.

As examples, the computer that executes the program may store the program recorded on a portable recording medium or the program transferred from the server computer in its own storage device. The computer may then read out the program from its own storage device and execute processing according to the program. Note that it is also possible for the computer to read the program directly from the portable recording medium and execute processing according to the program.

It is also possible for a computer to sequentially execute processing according to a received program each time the program is transferred from a server computer connected via the network. Also, at least some of the processing functions described above may be realized by electronic circuits, such as a DSP, an ASIC, or a PLD.

According to the present embodiments, it is possible to update firmware while preventing security holes.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing system comprising:
a peripheral including a device that operates on embedded software and a converter that performs conversion of communication interface for inputs into the device based on a mode setting; and
an information processing apparatus including a controller that sets, when updating the embedded software of the device, the converter in a conversion mode to cause the converter to perform conversion of embedded software that has been outputted for a first communication interface from the first communication interface to a second communication interface and performs updating of the embedded software of the device using the second communication interface, and sets, when not updating the embedded software, the converter in a non-conversion mode to stop the conversion from the first communication interface to the second communication interface and stops updating of the embedded software of the device.

2. The information processing system according to claim 1, wherein
the device is a relay device that relays and controls communication between the information processing apparatus and the peripheral via a relay connector including an expansion bus, and
the controller performs updating of the embedded software of the relay device based on the conversion of communication interface by the converter.

3. The information processing system according to claim 2, wherein
the peripheral further includes a manual switch, and
the information processing system further comprises two routes composed of a first route that outputs a state setting signal, which sets the relay device in an updateable state or an updating stopped state for the embedded software, from the controller to the relay device and a second route that generates the state setting signal at the manual switch and outputs the state setting signal from the manual switch to the relay device.

4. The information processing system according to claim 3, wherein
the controller is operable when the relay device has been set in the updateable state based on the state setting signal transmitted via the first route, to set the converter in the conversion mode and to cause the converter to convert the embedded software for the first communication interface outputted from the controller to the second communication interface, and
the controller is operable when the relay device has been set in the updating stopped state based on the state setting signal transmitted via the first route, to set the converter in the non-conversion mode and to stop the conversion from the first communication interface to the second communication interface.

5. The information processing system according to claim 3, wherein
the peripheral further includes a connector that connects signals transmitted from outside using the first communication interface,
the controller is operable when the relay device has been set in the updateable state based on the state setting signal transmitted via the second route, to set the converter in the conversion mode and to cause the converter to convert the embedded software for the first communication interface inputted from outside via the connector to the second communication interface, and
the controller is operable when the relay device has been set in the updating stopped state based on the state setting signal transmitted via the second route, to set the converter in the non-conversion mode and to stop the conversion from the first communication interface to the second communication interface.

6. The information processing system according to claim 2, wherein as the conversion from the first communication interface to the second communication interface, the converter converts from a general-purpose serial bus communication interface to a general-purpose asynchronous serial bus communication interface.

7. The information processing system according to claim 1, wherein the device is a power supply device that controls supplying of power, and the controller updates the embedded software of the power supply device based on the conversion of communication interface by the converter.

8. The information processing system according to claim 7, wherein
the peripheral further includes a switch that switches between a first switching state that connects the converter and the power supply device using the second communication interface and a second switching state that connects the controller and the power supply device using the second communication interface,
the converter is operable when the conversion mode has been set by the controller, to set the power supply device in an updateable state for the embedded software, to execute conversion to the second communication interface of the embedded software for the first communication interface outputted from the controller, to set the switch in the first switching state, and to output the embedded software outputted using the second communication interface via the switch to the power supply device, and
the converter is operable when the non-conversion mode has been set by the controller, to set the power supply device in an updating stopped state for the embedded software, to stop the conversion from the first communication interface to the second communication interface, to set the switch in the second switching state, and to cause the controller and the power supply device to communicate via the switch using the second communication interface.

9. The information processing system according to claim 7, wherein as the conversion from the first communication interface to the second communication interface, the converter converts from a general-purpose serial bus communication interface to a synchronous serial bus communication interface.

10. An information processing apparatus comprising:
a controller that is connected to a peripheral including a device that operates on embedded software and a converter that performs conversion of communication interface for inputs into the device based on a mode setting, sets, when updating the embedded software of the device, the converter in a conversion mode to cause the converter to perform conversion of embedded software that has been outputted for a first communication interface from the first communication interface to a second communication interface and performs updating of the embedded software for the device using the second communication interface, and sets, when not updating the embedded software, the converter in a non-conversion mode to stop the conversion from the first communication interface to the second communication interface and stops updating of the embedded software of the device.

11. A non-transitory computer-readable recording medium storing therein a computer program that causes a computer to execute a process comprising:
converting, when embedded software of a device that operates on the embedded software is updated and a conversion mode for performing conversion of a communication interface for inputs into the device has been set based on a mode setting from an outputter that outputs the embedded software, the embedded software outputted for a first communication interface from the first communication interface to the second communication interface and updating the embedded software of the device using the second communication interface; and
stopping, when the embedded software is not being updated and a non-conversion mode has been set based on the mode setting from the outputter, the conversion from the first communication interface to the second communication interface and stopping updating of the embedded software of the device.

12. The non-transitory computer-readable recording medium according to claim 11, wherein the process further includes:
setting, when the conversion mode has been set, the device in a updateable state for the embedded software, converting the first communication interface to the second communication interface, controlling a switch, which is disposed between the computer and the device, to set a first switching state for connecting the computer and the device by the second communication interface, and updating the embedded software outputted to the device via the switch using the second communication interface; and
setting, when a non-conversion mode has been set, the device in an updating stopped state for the embedded software, stopping the conversion from the first communication interface to the second communication interface, controlling the switch to set the switch in a second switching state for connecting the outputter and the device by the second communication interface, stopping updating of the embedded software of the device, and causing the outputter and the device to communicate via the switch using the second communication interface.
